(19) United States
(12) Patent Application Publication
(10) Pub. No.: US 2004/0023040 A1
(43) Pub. Date: Feb. 5, 2004

(54) Spherical metal oxide particles comprising particulate surface prominences, a method for producing the same and the use thereof

(76) Inventors: Carsten Gellermann, Gerbrunn (DE); Herbert Wolter, Tauberbischofsheim (DE); Werner Storch, Hochberg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/362,299

(22) PCT Filed: Aug. 21, 2001
(86) PCT No.: PCT/EP01/09608

(30) Foreign Application Priority Data
Aug. 22, 2000 (DE) 100 41 038.3

(51) Int. Cl. C01F 7/02; B32B 9/04

(52) U.S. Cl. 428/446; 423/600; 423/594.9

(57) ABSTRACT

The invention relates to spherical metal oxide particles with a particle diameter of between 5 nm and 10000 nm. Said particles contain at least one oxidic compound of elements that are selected from the first to fifth main groups, the transition metals and/or the lanthanoids and have particulate prominences on their surface.

The invention concerns spherical metal oxide particles which contain at least one metal oxide and which have a surface with particular elevations. The invention also concerns a method for the production of such spherical metal oxide particles and the use of the particles.

Spherical particles based on metal oxides are widely used in the most varied technical fields—for example, for the production of bulk materials, coatings, films, or fibers, for the production of optical, electrooptical, or optoelectronic components, in chromatography, as fillers or as carriers for pharmacologically active substances.

In many fields of application of spherical particles, their suitability very decisively depends on particle size, particle size distribution, and surface characteristics. Surface characteristics are of importance, for example, if the particles are to be used as fillers, if they are introduced into a matrix, or if they are used as carriers or in chromatography.

From DE 196 43 781.4 A1, spherical particles are known which have a size between 5 and 10,000 nm and contain SnO₂ as a metal oxide and at least one other oxide of the elements of the first to fifth main groups and/or the transition metals. An essential characteristic of these spherical particles is their surface modification. The surface modification of the particles was undertaken, in accordance with P 196 43 781.4 A1, in such a way that the surface was modified with organic groups. These particles fulfill many prerequisites, in particular, with reference to X-ray opacity, however, one disadvantage of these particles is also that their surface is not sufficiently large for many uses. The particles of the state of the art, however, have other disadvantages. Thus, binding into a matrix is possible only insufficiently so that desired reinforcement of a composite can be only conditionally attained. Furthermore, the range of the adjustable characteristics is limited.

Proceeding from this, therefore, the goal of the invention under consideration is to propose novel metal oxide-containing spherical particles and a corresponding production method, which [particles] have an enlarged surface in comparison to the state of the art, and which at the same time, make possible effective binding to various matrices.

The goal with regard to the spherical particles is attained by the characterizing features of claim 1 and with regard to the method for the production, by the features of claim 11, and with regard to the use, by the features of claim 19.

The subclaims indicate advantageous refinements.

The spherical particles in accordance with the invention accordingly have particular structures on their surface. In this way, a so-called “hedgehog-like” particle is formed. The decisive advantage of the particles in accordance with the invention is thus to be found, on the one hand, in the surface enlargement and thus in the effective binding to a polymer matrix. The particles in accordance with the invention are also characterized in that anchoring (push button effect) occurs with the particular elevations during incorporation into a polymer matrix and thus physical reinforcement by the surface structure of the particles. In this way, the range of the adjustable mechanical characteristics of the resulting composite is clearly expanded. Advantages when used in catalysis or chromatography are also found due to the enlarged surface. Moreover, these particles can be used as a novel precursor for ihe production of nanostructured materials, for example, ceramics, and coatings with sensory characteristics.

The particular elevations on the surface are preferably spherical in shape and protrude a maximum of 40%, with particular preference 10%, of the sphere's radius from the surface. The particular elevations are almost uniformly distributed over the spherical surface of the metal oxide particles.

From a material perspective, the invention comprises all spherical metal oxide particles which contain at least one oxidic compound of elements, selected from the first to fifth main groups and/or transition metals and/or lanthanides and/or actinides.

Preferably, the metal oxide particles contain oxides of the following metals: Si, Sn, Ti, Zr, Al, Sr. With particular preference, it is in the spherical metal oxide particles in accordance with the invention that at least two different metal oxides are contained. For this case, it is then possible that the metal oxide particles have a different structure. Thus, the metal oxide particles can be structured like an onionskin-that is, a metal oxide forms the core and the second metal oxide forms a shell around the first core. In accordance with the invention, several shells of additional and/or the same metal oxides can also be added one over another here.

A second possibility of being structured like the metal oxide particles is to be found in that the at least two metal oxides are homogeneously distributed.

Thirdly, it is also possible that a heterogeneous structure is present. A “heterogeneous structure,” in accordance with the invention, is understood to mean that heterogeneous areas-that is, nanoparticles of a metal oxide-are contained in the particle itself. In accordance with the invention, different metal oxide particles can also be located here as heterogeneous areas in a metal oxide particle—that is, in a matrix.

An essential feature of all metal oxide particles in accordance with the invention however, is that they have the particular structure on the surface which is described in more detail in the preceding. The particles in accordance with the invention are particularly advantageous if they are used in a composite. The binding of the particles is apparently substantially improved by the physical effect (push button effect), in comparison to known particles without elevations. The elevations on the surface thus apparently lead to an indenting or hooking up with the matrix of the composite. It should also be stressed that this surprising effect appears in addition to the chemical binding known from the state of the art.

With the metal oxide particles in accordance with the invention, it is also surprising that surface modification is possible. It has become evident that a homogeneous coating of the surface permeated with elevations occurs without local accumulations. This is all the more surprising since the particles and their elevations can be made of various materials. The surface modification is preferably obtained by a partial or complete hydrolytic condensation, by the effect of water or moisture, of one or more hydrolytically condensable compounds of silicon and optionally other elements from the group boron, aluminum, phosphorous, tin, lead, transition metals, lanthanides, and actinides, and/or precondensation products derived from the aforementioned compounds, optionally in the presence of a catalyst and/or a solvent. The binding of the compounds to the particles, obtained by the aforementioned condensation takes place via reactive groups on the surface, such as OH groups. This surface modification is already known from DE 196 43 781.4 A1. Therefore, reference is made to the complete disclosure of this document.

The compounds described in DE 196 43 781.4 A1 can be derived from various monomers, wherein general formulas of such examples are mentioned below:

Rₐ(Z′R″)_{b} MX_{c}-(a+b) (I)

in which the radicals and indices have the following meanings:

R=alkyl, alkenyl, aryl, alkylaryl, or arylalkyl;

R″=alkylene, or alkenylene, wherein these radicals can contain oxygen, sulfur atoms and/or amino groups;

X=hydrogen, halogen, hydroxy, alkoxy, acyloxy, alkylcarbonyl, alkoxycarbonyl, or NR′₂, with R′=hydrogen, alkyl, or aryl;

Z′=halogen or an optionally substituted amino, amide, aldehyde, alkylcarbonyl, carboxyl, mercapto, cyano, alkoxy, alkoxycarbonyl, sulfonic acid, phosphoric acid, acryloxy, methacryloxy, epoxy, or vinyl group;

a=0, 1, 2, 3, 4, 5, 6, or 7;

b=0, 1, 2, 3, 4, 5, 6, or 7with a+b=1, 2, 3, 4, 5, 6, or 7;

c=1, 2, 3, 4, 5, 6, 7, or 8; and

M=elements of the 1st to 5th main groups or the transition metals, lanthanides, and actinides.

The following elements are preferred: silicon, aluminum, titanium, ytrium, zirconium, strontium, rubidium, vanadium, and antimony.

The values a, b, and c thereby depend on the metal M.

1.1 Examples of Possible Organometallic Compounds

1.1.1 MeSi(OEt)₃, n-BuSi(OCH₃)₃, EtSi(OAc)₃ H₂N (CH₂)₃Si (OCH₃)₃, Et₂Si (OEt)₂, Si (OR)₄

1.1.2 Al(OR)₃, Al(acac)₃, EtAlCl₂

1.1.3 Ti(OR)₄, TiCl₃

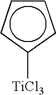

1.1.4 Sb(OR)₃, SbCl₅, Ph₃SbCl₂

1.1.5 YCl₃, Y (OCH₂CH₂OCH₃) ₃

1.1.6 Zr(OR)₄,

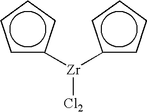

1.1.7 Sr(acac)₂, St(OH) ₂

1.1.8 Rb (OAc)₂, Rb (acac)₂

1.1.9 VO(O-<)₃, V(acac)₃, VCl₄

2. Rₐ (Z′ R″)_{b} SnX_{c-(}a+b) (II)

in which the radicals and indices have the following meanings:

R alkyl, alkenyl, aryl, alkylaryl, or arylalkyl;

R″=alkylene, or alkenylene, wherein these radicals can contain oxygen, sulfur atoms and/or amino groups;

X=hydrogen, halogen, hydroxy, alkoxy, acyloxy, alkylcarbonyl, alkoxycarbonyl, or NR′₂, with R′=hydrogen, alkyl, or aryl;

Z′=halogen or an optionally substituted amino, amide, aldehyde, alkylcarbonyl, carboxyl, mercapto, cyano, alkoxy, alkoxycarbonyl, sulfonic acid, phosphoric acid, acryloxy, methacryloxy, epoxy, or vinyl group;

a=0, 1, 2, 3;

b=0, 1, 2, or 3 with a+b=1, 2, or 3;

c=2, 4.

2.1 Examples of Organic Compounds With Sn

Sn (OR)₄, Sn (OR)₂, Bu₂Sn (OMe)₂, PhSnCl₃

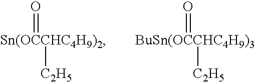

3. Rₐ(Z′ R″)_{b} SiX_{c-(}a+b) (III)

in which the radicals and indices have the following meanings

R=alkyl, alkenyl, aryl, alkylaryl, or arylalkyl;

R″=alkylene, or alkenylene, wherein these radicals can contain oxygen, sulfur atoms and/or amino groups;

X=hydrogen, halogen, hydroxy, alkoxy, acyloxy, alkylcarbonyl, alkoxycarbonyl, or NR′₂, with R′=hydrogen, alkyl, or aryl;

Z′=halogen or an optionally substituted amino, amide, aldehyde, alkylcarbonyl, carboxyl, mercapto, cyano, alkoxy, alkoxycarbonyl, sulfonic acid, phosphoric acid, acryloxy, methacryloxy, epoxy, or vinyl group;

a=0, 1, 2, or 3;

b=0, 1, 2, or 3with a+b=1, 2, or 3;

c=2 or 4.

4. [symbol] XₐR_{b}Si[(R′A)_{c}]_{(4-a-b}) [symbol] ₓB (IV)

The radicals and indices are the same or different and have the following meanings:

A=O, S, PR″, POR″, NHC(O)O or NHC(O)NR″

B=a straight-chain or branched organic radical, which is derived from a compound B′ with at least one (for c=1 and A═NHC(O)O or NHC(O)NR″) or at least two C═C double bonds and 5 to 50 carbon atoms;

R=alkyl, alkenyl, aryl, alkylaryl, or arylalkyl;

R′=alkylene, arylene, or alkylenearylene;

R″=hydrogen, alkyl, or aryl;

X=hydrogen, halogen, hydroxy, alkoxy, acyloxy, alkylcarbonyl, alkoxycarbonyl, or NR″₂;

a=1, 2, or 3;

b=0, 1, or 2; c=0 or 1;

x=a whole number, whose maximum value of the number of double bonds in the compound corresponds to B′ minus 1, or is equal to the number of double bonds in the compound B′, if c=1 and A stands for NHC(O)O or NHC(O)NR″;

wherein the alkyl or alkenyl radicals are optionally substituted, straight-chain, branched, or cyclic radicals with 1 to 20 carbon atoms and can contain oxygen, sulfur atoms, and/or amino groups; aryl stands for optionally substituted phenyl, naphthyl, or biphenyl; and the above alkoxy, acyloxy, alkylcarbonyl, alkoxycarbonyl, alkylaryl, arylalkyl, arylene, alkylene, and alkylenearyl radicals can be derived from the alkyl and aryl radicals defined above.

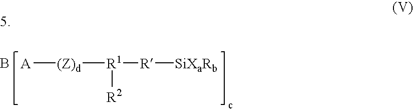

wherein the radicals and indices are the same or different and can have the following meanings:

B=a straight-chain or branched organic radical with at least one C═C double bond and 4 to 50 carbon atoms;

X=hydrogen, halogen, hydroxy, alkoxy, acyloxy, alkylcarbonyl, alkoxycarbonyl, or NR″₂;

R=alkyl, alkenyl, aryl, alkylaryl, or arylalkyl;

R′=alkylene, arylene, or arylenealkylene or alkylenearylene with 0 to 10 carbons each, wherein these radicals can contain oxygen, sulfur atoms, and/or amino groups;

R″=hydrogen, alkyl, or aryl;

A=O, S, or NH for

d=1 and

Z=CO and

R¹=alkylene, arylene, or alkylene arylene, optionally containing oxygen, sulfur atoms, and/or amino groups, with 1 to 10 carbon atoms each; and

R²=H or COOH or

A=O, S, NH, or COO for

d=0 or 1; and

Z=CHR, with R═H, alkyl, aryl, or alkylaryl; and

R¹=alkylene, arylene, or alkylene arylene, optionally containing oxygen, sulfur atoms, and/or amino groups, with 1 to 10 carbon atoms; and

R²=OH; or

A=S for

d=1; and

Z=CO; and

R¹=N; and

R²=H;

a=1, 2, or 3;

b=0, 1, or 2, with a+b=3;

c=1, 2, 3, or 4.

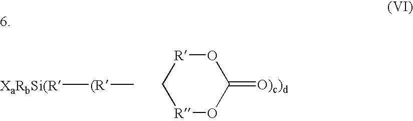

wherein here the radicals and indices are the same or different and can have the following meanings:

p0 X=hydrogen, halogen, hydroxy, alkoxy, acyloxy, alkylcarbonyl, alkoxycarbonyl, or NR₂²;

R=alkyl, alkenyl, aryl, alkylaryl, or arylalkyl;

R′=alkylene, arylene, or arylenealkylene or alkylenearylene with 0 to 10 carbons each, wherein these radicals can contain oxygen, sulfur atoms, and/or amino groups;

R″=alkylene, arylene, arylenealkylene, or alkylenearylene, and 1 to 10 C atoms each, wherein these radicals can contain oxygen, sulfur atoms, and/or amino groups.

R²=hydrogen, alkyl, or aryl;

a=1, 2, or 3;

b=0, 1, or 2, with a+b=1, 2, or 3;

c=1, 2, 3, 4, 5, or 6;

d=4-a-b.

7. YₙSiXₘR₄₋₍ₙ₊ₘ₎ (VII)

wherein the radicals can be the same or different and have the following meanings:

R=alkyl, alkenyl, aryl, alkylaryl, or arylalkyl;

X=hydrogen, halogen, hydroxy, alkoxy, acyloxy, alkylcarbonyl, alkoxycarbonyl, or NR′₂, with R′=hydrogen, alkyl, or aryl;

Y a substituent containing a substituted or unsubstituted 1,4,6-trioxaspiro[4,4]nonane radical;

n=1, 2, or 3;

m=1, 2, or 3, withn+m≦4.

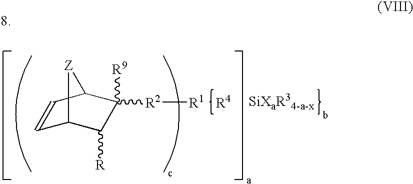

in which the radicals and indices can be the same or different and have the following meanings:

R=hydrogen, R²—R¹—R⁴—SiXₓR³_{3-x′}, carboxyl, alkyl, alkenyl, aryl, alkylaryl, or arylalkyl with 1 to 15 carbon atoms each, wherein these radicals can contain oxygen or sulfur atoms, ester, carbonyl, amide or amino groups;

R¹=alkylene, arylene, arylenealkylene, or alkylarylene with 0 to 15 carbon atoms each, wherein these radicals can contain oxygen or sulfur atoms, ester, carbonyl, amide, or amino groups;

R²=alkylene, arylene, arylenealkylene, or alkylarylene with 0 to 15 carbon atoms each, wherein these radicals can contain oxygen or sulfur atoms, ester, carbonyl, amide or amino groups;

R³=alkyl, alkenyl, aryl, alkylaryl, or arylalkyl with 1 to 15 carbon atoms, wherein these radicals can contain oxygen or sulfur atoms, ester, carbonyl, amide, or amino groups;

R⁴=—(CHR⁶—CHR⁶)ₙ— with n=0 or 1, —CHR⁶—CHR ⁶—S—R⁵—, —CO——S—R⁵—, —CHR⁵—CHR⁶—NR⁶—R⁵—, —Y—CS—NH—R⁶—, —S—R⁵, —Y—CO—NH—R⁵—, —CO—O—R⁵—, —Y—CO—C₂H₃(COOH)—R⁵—, —Y—CO₂—C₃(OH)—R⁵—or —CO—NR⁶—R₅—;

R⁵=alkylene, arylene, arylenealkylene, or alkylarylene with 1 to 15 carbon atoms each, wherein these radicals can contain oxygen or sulfur atoms, ester, carbonyl, amide, or amino groups;

R⁶=hydrogen, alkyl, or aryl with 1 to 10 carbon atoms;

R⁹=hydrogen, alkyl, alkenyl, aryl, alkylaryl, or arylalkyl with 1 to 15 carbon atoms each, wherein these radicals can contain oxygen or sulfur atoms, ester, carbonyl, amide, or amino groups;

X=hydrogen, halogen, hydroxy, alkoxy, acyloxy, alkyl carbonyl, alkoxycarbonyl, or NR″₂, with R″=hydrogen, alkyl or aryl;

Y=—O—, —S—, or —NR⁶—;

Z=—O— or —(CHR⁶)ₘ—, with m=1 or 2;

a=1, 2, or 3, with b=1 for a=2 or 3;

b=1, 2, or 3,witha=1 for b=2 or 3;

c=1 to 6;

x=1, 2, or 3;

a+x=2, 3, or 4.

In Examples 3 to 8, the used Si compounds make possible a great variability with the attained influence on the characteristics. In addition to the fraction of solids, they can influence the mechanical characteristics, for example, the impact resistance of the composite. The functional groups (for example, polymerizable double bonds), which are present in a relatively large number, ensure good binding of the filler in the resin or composite.

For example, a more flexible binding and thus a reduced E modulus and a greater thermal expansion coefficient can be set up with a long-chain methylene chain between the Si part and a functional group (C═C double bond), than is possible with a shorter chain between the Si part and the functional group. There are, however, other modifications of the characteristics possible, which cannot be implemented to such an extent with the reagents which are known from the state of the art and which have only one functional group. Thus, for example, an increased number of (meth)acrylate groups brings about a larger elasticity modulus (E modulus) and a smaller thermal expansion coefficient, in contrast to a few (meth)acrylate groups. With a greater number of alkoxy groups, a greater elasticity modulus and a smaller thermal expansion coefficient are also attainable.

The monomers mentioned under Examples 1 and 2, which are derived according to general formulas I and II, can also be used for desired modification in the interior of the spherical particles in accordance with the invention wherein here also, a+b can be 0. Water glass solutions can also be used for the modification in the interior.

It should be stressed in particular that due to the large number of possibilities for modification of the surface, in combination with the particular elevations on the surface in accordance with the invention a broad application field of the particles in accordance with the invention is possible. In the introduction of these particles into composites, there is reinforcement of the binding due to the physical effect and the chemical binding. In this way, the particles of the invention stand out clearly in comparison to the particles which are known from the disclosure document (Offenlegungsschrift), mentioned in the preceding.

The invention also concerns a method for the production of spherical particles with a particular surface.

In accordance with the invention, the procedure is such that in a first step, the metal oxide particles are produced according to methods which are in fact known, such as the sol-gel method, in particular the drift, the emulsion or aerosol methods (for example, spray-drying) and then in a following step, the particles thus produced are treated with energy.

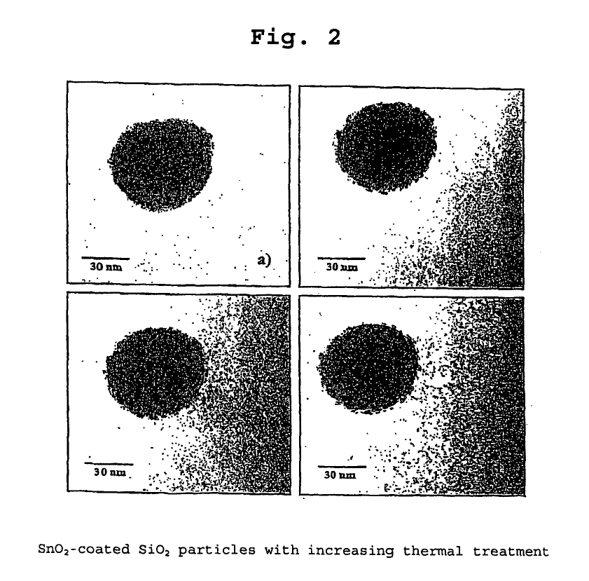

Surprisingly, the corresponding particular structures are formed in the shape of a “hedgehog-like” formation by the energy treatment-for example, tempering, laser treatment, and/or electron beam treatment (see FIG. 2).

Tempering can preferably take place by a temperature treatment in the range of 600° C. to 1000° over a time period of 10-90 min.

The production of the metal oxide particles themselves takes place according to previously known methods. In this respect, reference is made to DE 42 19 287 A1, EP 0 391 447 B1, and DE 196 43 781.4 A1.

The spherical particles in accordance with the invention can be obtained basically by means of a one-pot synthesis in situ also; optionally, colloidal sols obtained commercially could be subjected to an organic surface modification in a dispersion, in situ, by means of a multistep one-pot synthesis, as it is described in various variants in more detail below.

The particles in accordance with the invention can thereby have an onionskin-like structure, in which, in addition to at least one oxidic compound of the elements of the first to fifth main groups, transition metals, and/or lanthanides, at least one other oxide of the elements of the first to fifth main groups and/or transition metals and/or lanthanides, an additional shell is formed. One or more shell-like oxide layers are formed thereby around a centrally located core, which is also made of an oxide. Such a structure can be produced, for example, on the basis of a sol-gel process.

The production can also take place by means of an emulsion method. At least one element of the first to fifth main groups, transition metals, and/or lanthanides is emulsified, as an oxide (hydrate) that can be precipitated, in dissolved form or in the form of a sol in an aqueous phase, using an emulsifier in an organic liquid. The precipitation of the SnO₂ hydrate or other oxide (hydrates) in the emulsified water droplets is effected by dissolving at least one compound [chosen] from quaternary ammonium, phosphonium, and other onium compounds and salts of long-chain organic acids, before, during or after the formation of the emulsion, wherein the pertinent compound is either already present in the OH or H form or is produced in situ, after which the water is removed by distillation.

Small particles can be embedded in larger particles whose matrix consists of the same or another oxide, with the emulsion method, so as to obtain a composite structure of the particles. Such a structure can also be attained if small particles grow into larger ones.

Particles with a homogeneous distribution of various oxides in the pertinent particle can be obtained by joint hydrolysis and condensation with various metal oxide precursors (for example, metal alcoholates, alkyl carbonyls).

Metal oxide particles which contain an oxide of the metals Si, Sn, Ti, Zr, Al, or Sr, or a mixture thereof are preferably produced.

The invention is described in more detail below with the aid of two figures and an embodiment.

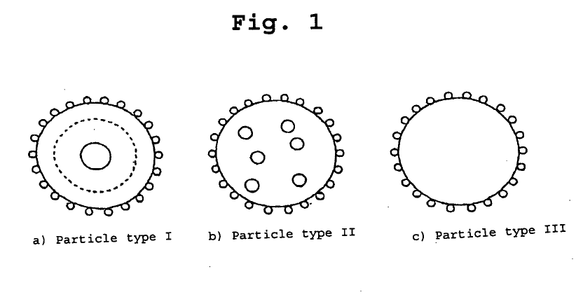

FIG. 1 shows schematically three particle types in the overall view;

FIG. 2 shows electron micrographs of the formation of the particular structures.

FIG. 1 shows schematically in the overall view how the spherical metal oxide particles are structured. FIG. 1 shows a particle type with [Sic; FIG. 1a shows a particle type] which has a shell-like structure and on whose surface the particular structures, schematically alluded to, are located in the form of spherical elevations.

FIG. 1b shows schematically a metal oxide particle which contains heterogeneous areas-that is, nanoparticles. The surface formation corresponds to the type in FIG. 1a.

FIG. 1c shows a particle, which in the interior, has a homogeneous distribution, and in the exterior, again, the particular surface shape known already from FIGS. 1a and b.

FIG. 2 shows electron micrographs during the production process-that is, during the tempering of a selected particle. The particle shown in FIG. 2 is an SnO2 particle, which is coated with SiO₂. This is a shell structure, as shown in FIG. 1a in the preceding. The sequence under FIGS. 2a-d shows, impressively, how the surface formation takes place in the form of the particular structures during the tempering, with increasing time. The micrographs of FIGS. 2a, b, c, and d were taken over the time period of 2 min.

### EXAMPLES

1. SnO₂ Particle Coating on an SiO₂ Core

Production of the 60-nm, spherical SiO₂ core, on the basis of the Stöber method:

180 mL 12.1M ammonia and 3600 mL ethanol are brought together at 21° C. and stirred. 180 g Tetraethoxysilane (TEOS) are added all at once. Within 20 min, the solution becomes murky. After 1 h, centrifuging takes place, and the isolated particles are washed twice with alcohol. Size: 60±5 nm (TEM)

Coating of the SiO₂ Core with SnO₂:

A 10 wt % alcohol solution of tin(IV) tert-butoxide is added, all at once, to an alcohol solution containing 1 wt % SiO₂ core and is heated to boiling, over a time period of 4 h. After cooling to room temperature, a 1% water-containing alcohol solution is metered in at a rate of 0.02 mL/min. Slow stirring of the dispersion follows over the next 3 h. Afterwards, the particles are isolated by centrifugation, and washing with alcohol over redispersion/centrifugation cycles is carried out twice.

SnO₂ content: 5 wt % (RFA [X-ray fluorescence analysis]), size: 64±8 nm (TEM, see FIG. 4a)

2. Production of the Particular Surface Structures on Particles of Example 1 by a Subsequent Thermal Treatment

The SnO₂-coated SiO₂ particles are treated thermally in a furnace at 700° C., over a time period of 60 min. The micrographs obtained on a transmission electron microscope are shown in FIG. 2, as a function of the treatment time.

3. Surface Modification

1 g of the “hedgehog” [particles], obtained in Example 2, is dispersed in 100 g toluene; 2 g methacryloxypropyltrimethoxysilane are added and heated to boiling for 5 h. After cooling to room temperature, the particles are isolated by means of centrifugation and washed twice with toluene over redispersion/centrifugation cycles. The drying is carried out in an oil pump vacuum over 7 h at 100° C. The modification is detected by means of diffuse reflection infrared Fourier transformation spectroscopy (DRIFTS), with the aid of oscillation at 1720 and 1636 cm⁻¹, which is specific for C═O and C═C double bonds.

4. Production of Particular Surface Structures on Particles of Example 1 by Means of Electron Bombardment

SnO₂-coated SiO₂ particles from Example 1 are focused in a transmission electron microscope. Micrographs are taken over a time period of a few minutes, at intervals of approximately 15 sec. The images obtained correspond to those of Example 2 with the difference that here, the treatment times between the individual photos are merely approximately 15 sec.

1. Spherical metal oxide particles with a particle diameter of 5 nm to 10,000 nm, which contain at least one oxidic compound from elements selected from the first to fifth main groups, transition metals, and/or lanthanides, and/or actinides, characterized in that they have particular elevations on the surface.

2. Spherical metal oxide particles according to claim 1, characterized in that the elevations are essentially spherical and protrude a maximum of 40% of the sphere's radius of the metal oxide particles from the surface.

3. Spherical metal oxide particles according to claim 2, characterized in that they protrude a maximum of 10% from the surface.

4. Spherical metal oxide particles according to at least one of claims 1 to 3, characterized in that the particular elevations are uniformly distributed over the particle surface.

5. Spherical metal oxide particles according to at least one of claims 1 to 4, characterized in that the particles contain at least two metal oxides.

6. Spherical metal oxide particles according to claim 5, characterized in that they have an onionskin-like structure.

7. Spherical metal oxide particles according to claim 5, characterized in that they have a homogeneous distribution of the metal oxides.

8. Spherical metal oxide particles according to claim 5, characterized in that at least one metal oxide is present in the form of nanoparticles, which are located within the metal oxide particle.

9. Spherical metal oxide particles according to at least one of claims 1 to 8, characterized in that they have a surface modification, which [particles] were obtained by partial or complete hydrolytic condensation, by the effect of water or moisture, of one or more hydrolytically condensable compounds of the silicon and optionally, other elements from the group B, Al, P, Sn, Pb, the transition metals, the lanthanides, and the actinides, and/or the precondensation products derived from the aforementioned compounds, optionally in the presence of a catalyst and/or a solvent, wherein the compounds are bound via reactive groups on the surface of the particles.

10. Spherical metal oxide particles according to at least one of claims 1 to 9, characterized in that their size is in the range of 20-500 nm.

11. Method for the production of spherical particles, containing metal oxide, with a particular surface with a particle diameter of 5-10,000 nm, in which the metal oxide-containing particles are produced by means of a sol-gel method, in particular, a drift, emulsion, or aerosol method and the particles produced in this manner are subsequently subjected to an energy treatment.

12. Method according to claim 11, characterized in that the metal oxide-containing particles are produced in that one or more shells of metal oxides and/or metal oxide mixtures are applied on spherical metal oxide particles, which contain at least one oxidic compound of elements of the first to fifth main groups of the transition metals [sic; main groups, transition metals] and/or the lanthanides, by hydrolytic condensation, by the effect of water or moisture, of one or more hydrolytically condensable compounds of the elements of the first to fifth main groups of the transition metals, and/or lanthanides, and/or the precondensation products, derived from the aforementioned compounds, optionally in the presence of a catalyst and/or a solvent.

13. Method according to claim 11, characterized in that the metal oxide-containing particles are produced in that hydrolytically condensable metal compounds of the elements of the first to fifth main groups of the transition metals, and/or the lanthanides, and/or precondensation products derived from the aforementioned compounds, are subjected to a hydrolytic condensation, by the effect of water or moisture, optionally in the presence of a catalyst and/or a solvent.

14. Method according to claim 11, characterized in that at least one element of the first to fifth main groups, the transition metals, and/or the lanthanides is contained as an oxide (hydrate), which can be precipitated, in dissolved form or in the form of a sol in an aqueous phase and is emulsified using an emulsifier in an organic liquid, and the precipitation of the hydrate or other oxide (hydrates) in the emulsified water droplets by dissolving at least one compound selected from quaternary ammonium, phosphonium, and other onium compounds and salts of long-chain organic acids, is effected before, during, or after the formation of the emulsion, wherein the pertinent compound is either already present in the OH or H form or is produced in situ, after which the water is removed by distillation.

15. Method according to at least one of claims 12 to 14, characterized in that metal oxide particles are produced which contain an oxide of the metals Si, Sn, Ti, Zr, Al, or Sr, or a mixture thereof.

16. Method according to at least one of claims 11 to 15, characterized in that the particles are subjected to an energy treatment by temperature treatment.

17. Method according to claim 16, characterized in that the temperature treatment takes place over a time period of 10-90 min and at 600-1000° C.

18. Method according to at least one of claims 11 to 15, characterized in that the particles are subject to an energy treatment by laser and/or electron beams.

19. Use of particles according to one of claims 1 to 10 for the production of bulk materials, coatings, films, or fibers, for the production of optical, electrooptical, or optoelectronic components, in chromatography, as fillers, as carriers for pharmacologically active substances, in bioanalysis, in catalysis, and sensory technology, or in medical or dental technology.
